(19) United States
(12) Patent Application Publication
(10) Pub. No.: US 2022/0107711 A1
(43) Pub. Date: Apr. 7, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventors: Kosuke TOMOKUNI, Kanagawa (JP); Junichi SHIMIZU, Kanagawa (JP); Mamiko SATO, Kanagawa (JP); Shusaku KUBO, Kanagawa (JP)

(73) Assignee: FUJIFILM Business Innovation Corp., Tokyo (JP)

(21) Appl. No.: 17/321,487

(22) Filed: May 16, 2021

(30) Foreign Application Priority Data
Oct. 1, 2020 (JP) 2020-166861

(51) Int. Cl. G06F 3/0482; G06F 16/245; G06K 9/00; G06K 9/62

(52) U.S. Cl. CPC G06F 3/0482; G06F 16/245; G06K 9/00469; G06N 20/00; G06K 9/6263; G06K 9/6255; G06K 9/00449

(57) ABSTRACT

An information processing apparatus includes a processor configured to select candidates for second data to be associated with first data, the first data being data which is set by a first apparatus among plural apparatuses constituting a workflow, the second data being data pieces which are set by apparatuses other than the first apparatus among the plural apparatuses, based on a first similarity which is a similarity between names of the first data and the second data, and a second similarity which is a similarity between data formats of the first data and the second data, and generate a first screen in which, for each of the selected candidates, a name of the first data, a name of the candidate, and a name of the apparatus that sets the candidate are displayed in association with each other, the first screen being used for receiving selection of the second data to be associated with the first data, from among the candidates.

### CROSS-REFERENCE TO RELATED APPLICATIONS

This application is based on and claims priority under 35 USC 119 from Japanese Patent Application No. 2020-166861 filed Oct. 1, 2020.

### BACKGROUND

### (i) Technical Field

The present invention relates to an information processing apparatus and a non-transitory computer readable medium storing a program.

### (ii) Related Art

A data linkage rule generation system disclosed in JP2005-063261A generates system linkage rule definition information indicating the association of data linked between business systems, based on business model definition information including information indicating the linkage of conceptual data used in each modeled business, and system physical specification mapping definition information indicating the association between the conceptual data used in the modeled business and the data used in the business system that processes the modeled business. A data control system links the data on the business system by using the generated system linkage rule definition information.

The system disclosed in JP6412924B visualizes the data definition from the upstream to the downstream, and sets any upstream attribute in the data mapping to the downstream. Attributes are automatically determined based on the component type.

A system disclosed in JP5903171B extracts meta information from a document, maps the extracted meta information by using related dictionary information (synonyms, translation dictionaries, conversion dictionaries for written and spoken words, etc.), and converts the meta information according to the mapped information.

A system disclosed in JP6542880B holds a plurality of import procedures as use cases, in the scene of importing from a data source to a data target. At the time of import, the use case that matches the conditions of the import parameters is selected, and the import procedure of the use case is executed.

### SUMMARY

In order to achieve a workflow using a plurality of apparatuses, it is necessary to associate the attributes set (for example, input) by the plurality of apparatuses with each other. At that time, with respect to a first attribute among a plurality of attributes set by a first apparatus among the plurality of apparatuses, a plurality of attributes set by the other plurality of apparatuses may be candidates for association.

Aspects of non-limiting embodiments of the present disclosure relate to an information processing apparatus and a non-transitory computer readable medium storing a program in which the worker causes more appropriate data among data input by the other apparatuses to be associated with first data, as compared with a case where only the name of data of each candidate to be associated with the first data is displayed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to select candidates for second data to be associated with first data, the first data being data which is set by a first apparatus among a plurality of apparatuses constituting a workflow, the second data being data pieces which are set by apparatuses other than the first apparatus among the plurality of apparatuses, based on a first similarity which is a similarity between names of the first data and the second data, and a second similarity which is a similarity between data formats of the first data and the second data, and generate a first screen in which, for each of the selected candidates, a name of the first data, a name of the candidate, and a name of the apparatus that sets the candidate are displayed in association with each other, the first screen being used for receiving selection of the second data to be associated with the first data, from among the candidates.

### BRIEF DESCRIPTION OF THE DRAWINGS

Exemplary embodiment(s) of the present invention will be described in detail based on the following figures, wherein:

FIG. 1 is a diagram illustrating an example of an overall system consisting of an attribute association system and a workflow system to which the attribute association system is applied;

FIG. 2 is a diagram illustrating an example of a form and attributes extracted from the form;

FIG. 3 is a diagram illustrating a hardware configuration of a computer;

FIG. 4 is a diagram illustrating an example of finding a score showing similarity between attributes;

FIG. 5 is a diagram illustrating another example of finding a score showing similarity between attributes;

FIG. 6 is a diagram for explaining a process of determining a source attribute to be displayed as an option in a GUI according to a score;

FIG. 7 is a diagram illustrating an example of source attributes presented on the GUI at different levels with respect to the required attributes of a target;

FIG. 8 is a diagram illustrating an example of display contents of the GUI;

FIG. 9 is a diagram illustrating an overall processing procedure of an attribute association system;

FIG. 10 is a diagram illustrating a procedure of a GUI generation process of the attribute association system;

FIG. 11 is a diagram illustrating a procedure for scoring evaluation of source attributes of the attribute association system;

FIG. 12 is a diagram illustrating an example of a progress screen; and

FIG. 13 is a diagram for explaining learning in a form in which the result of a user's selection is reflected in a name term dictionary.

### DETAILED DESCRIPTION

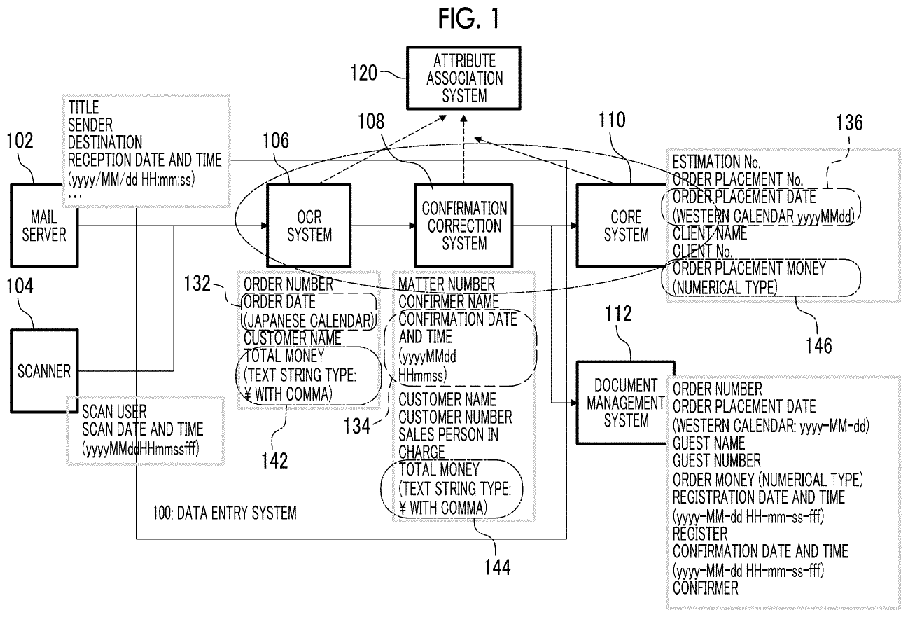

With reference to FIG. 1, an overall system consisting of an attribute association system 120 which is an exemplary embodiment of an information processing apparatus according to the present invention, and a workflow system to which the attribute association system 120 is applied will be illustrated. The workflow system illustrated in FIG. 1 includes subsystems such as a mail server 102, a scanner 104, a data entry system 100, a core system 110, and a document management system 112. This workflow system is for a process of digitizing and saving the contents of the form. Among subsystems, the mail server 102 and the scanner 104 are input systems for inputting image data of forms into the data entry system 100. Further, the core system 110 and the document management system 112 are subsequent systems in which the data entry system 100 receives and processes the digitized contents of the form.

The scanner 104, which is one of the input systems, scans a form such as paper, generates image data of the form (hereinafter referred to as a form image), and inputs the form image into the data entry system 100 via, for example, a network. Further, the form image generated by the scanner 104 and the form image entered by the user using the document editing system may be attached to the e-mail and input to the data entry system 100 via the mail server 102. Although not illustrated, the input of the form image to the data entry system 100 may be performed via an image transfer system such as a facsimile, in addition to the illustrated e-mail attachment and input from the scanner 104.

The data entry system 100 is a system that recognizes and digitizes the contents of a form such as paper. The data entry system 100 includes an OCR system 106 and a confirmation correction system 108.

The optical text recognition (OCR) system 106 executes text recognition on the input form image, and obtains a text string which is a value of each attribute in the form image. Here, the OCR system 106 may specify the value of each attribute, by using a known key-value extraction method. In the key-value extraction, a key text string representing an attribute such as “order date” or “total money” is recognized from the form image. Then, a text string that matches the data type of the attribute (for example, a number string that can correspond to the year, month, and date, and a number string that can correspond to the amount of money) in a predetermined location near the text string of the key is recognized as the value of that attribute.

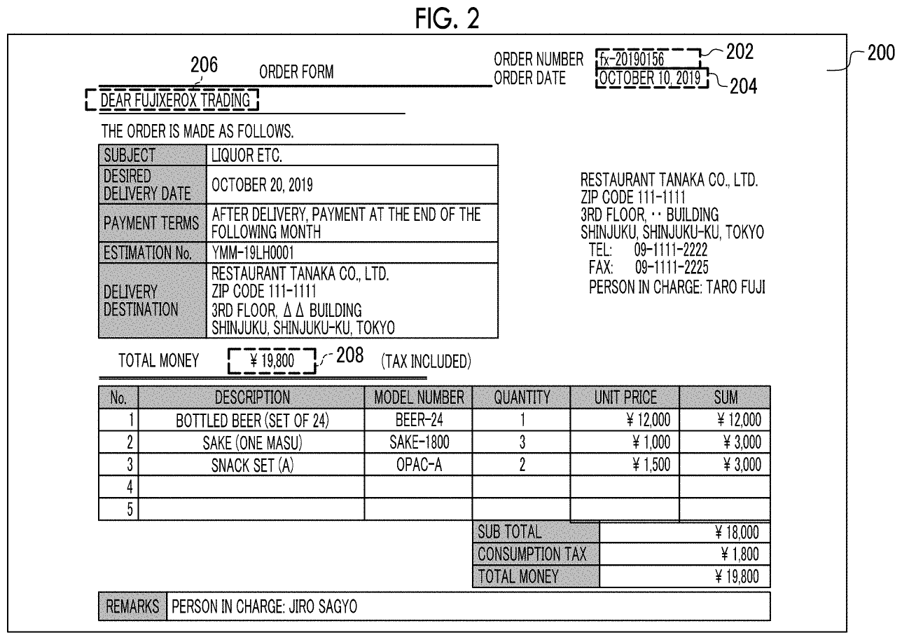

FIG. 2 illustrates an example of the form 200. This form 200 is an order form and includes attributes such as an order number 202, an order date 204, a customer name 206, and a total money 208.

The confirmation correction system 108 is a system that receives confirmation and correction by a human operator with respect to the text recognition result by the OCR system 106. The confirmation correction system 108 presents to the operator, for example, a confirmation screen in which for each attribute in the form, an image of the attribute and a text string of the text recognition result are displayed in association with each other. On the confirmation screen, the operator inputs an input for confirming that the text recognition result is correct in a case where the result is correct, and an input for correcting the result correctly in a case where the result is incorrect. The text strings of each attribute confirmed or corrected by the operator in this way are input to the core system 110 and the document management system 112, which are the subsequent systems.

The core system 110 is a system that performs information processing that is the core for the business of an organization that uses a workflow system. The core system 110 receives, from the data entry system 100, for example, data obtained by digitizing the contents of the form, that is, data of values (=text strings) for respective attributes, and executes an information processing of core business such as an accounting process according to the data.

The document management system 112 is a system for saving documents used in the business of an organization. For example, the document management system 112 saves digitized data of the form entry contents received from the data entry system 100 in association with the form image, and provides the saved information to the user.

In the workflow system illustrated in FIG. 1, the process related to the same form proceeds in the order of the OCR system 106, the confirmation correction system 108, and the core system 110 (or the document management system 112). In this way, in the processing order of workflow, the front side (that is, temporally early) is referred to as “upstream” and the back side is referred to as “downstream”, hereinafter. For example, the OCR system 106 and the confirmation correction system 108 are “upstream.” subsystems as seen from the core system 110, and the confirmation correction system 108 is an “downstream.” subsystem as seen from the OCR system 106.

The mail server 102, the scanner 104, the OCR system. 106, the confirmation correction system 108, the core system 110, and the document management system 112 that constitute the workflow system set the values of some attributes with respect to the input form. “Setting” an attribute value by a system means incorporating the attribute value into the output data of the system, or incorporating the attribute value into the input data to information processing (including registration in the database) of the system. In the following, in order to avoid the above-described complexity, the “attributes set by the system” may be simply referred to as “system attributes”.

For example, the mail server 102 extracts the values of attributes such as the title, destination, and reception date and time, from the data on the e-mail to which the form image is attached, associates the extracted value of each attribute with the form image, and outputs to the data entry system which is the subsequent stage in a workflow.

Further, the OCR system 106 recognizes attributes such as the order number, the order date 132, the customer name, and the total money 142 and the values of the attributes, from the form image, and outputs the recognized value of each attribute to the next confirmation correction system 108. In this example, in the attribute of total money 142, a data type of “text string type: with Ycomma” is set as the data type of the value of the attribute. This setting indicates that the value of the total money 142 is a text string type, has a “Y” mark at the beginning, and is separated by a comma for each predetermined number of digits.

Further, for example, the confirmation correction system 108 incorporates the value of the confirmation result or the correction result of each attribute of the form image input from the OCR system 106 and the value of another attribute input by the operator or the confirmation correction system 108 itself into the output data to the subsequent core system 110 and the document management system 112. Examples of the attributes set by the confirmation correction system 108 include the matter number, the confirmer name, the confirmation date and time 134, the customer name, the customer number, the sales person in charge, the total money 144, and the like. Of these, the customer name and the total money 144 are the results of confirmation or correction by the operator regarding the value of the attribute of the same name input from the OCR system 106. Further, for example, the values of the attributes of the confirmer name, the confirmation date and time, and the customer number are input or generated by the operator or the confirmation correction system 108 itself. In this example, a data type “yyyyMMddHHmmss” is defined for the value of the attribute of confirmation date and time 134. This data type is a number string in which 4-digit year “yyyy”, 2-digit month “MM”, 2-digit day “dd”, 2-digit hour “HH”, 2-digit minute “mm”, and 2-digit second “ss” are connected in this order.

Further, for example, the core system 110 inputs the value of each attribute input from each upstream system, for example, the confirmation correction system 108, into a core business application such as sales management, inventory management, and financial accounting. The attributes to be input include, for example, an estimation No., an order placement No., an order placement date 136, a client name, a client No., and an order placement money 146.

It should be noted here that the attribute of which value is set by each subsystem in the workflow may have an individual name (that is, an identification name) for each subsystem. This can happen in a case where the individual subsystems are developed separately. In this case, there may be a situation where the same attribute is given a different name for each subsystem.

Further, in a case where the data type of an attribute is designed for each subsystem, the data type of the same attribute may be different for each subsystem.

In a case where the attribute names are different at respective stages (that is, respective systems) of the workflow, the downstream subsystem may not be able to correctly inherit the attribute value set by the upstream subsystem. In order to avoid such a situation, in the related art, the attributes of respective subsystems have been manually associated with each other. However, it takes time and effort to respond manually. Therefore, in the present exemplary embodiment, the attribute association system 120 that supports the association between the attributes of the subsystems is provided.

The attribute association system 120 evaluates the similarity between the attributes set by respective subsystems in the workflow, and performs a support process for associating the attributes between the subsystems according to the evaluation result. The final determination on the association between attributes is made by a human user. The attribute association system 120 presents information to the user as a material for determining the association, and requests the user to make a final determination. The similarity between attributes is evaluated based on two factors: the similarity between attribute names and the similarity between attribute data formats. The attribute data format includes at least one of the data type or data length of an attribute value.

The process executed by the attribute association system 120 will be described in detail after the example of the computer hardware which is the base of the process is described.

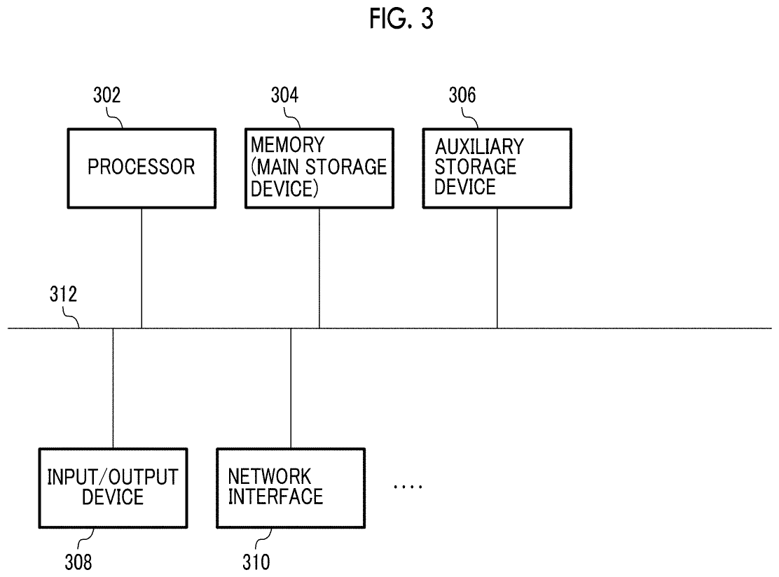

The attribute association system 120 is configured by using, for example, a general-purpose computer. As illustrated in FIG. 3, the computer, which is the base of the attribute association system. 120, has a circuit configuration in which a controller that controls a processor 302, a memory (main storage device) 304 such as a random access memory (RAM), an auxiliary storage device 306 that is a non-volatile storage device such as a flash memory, a solid state drive (SSD), and a hard disk drive (HDD), an interface with various input/output devices 308, a network interface 310 that controls connection to a network such as a local area network, and the like are connected via a data transmission path such as a bus 312. A program in which the contents of the processes of the above exemplary embodiment are described is installed in the computer via a network or the like, and stored in the auxiliary storage device 306. The attribute association system 120 is configured by executing the program stored in the auxiliary storage device 306 by the processor 302 using the memory 304.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

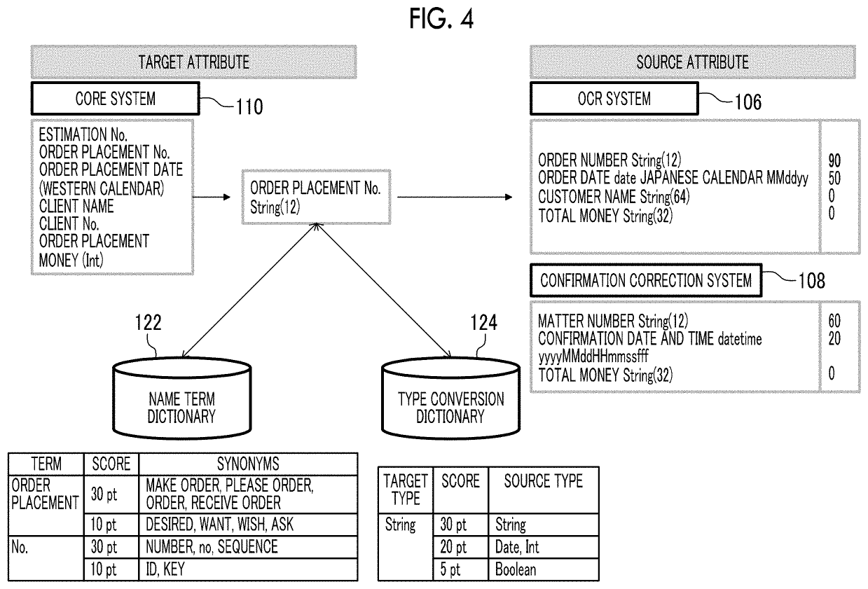

Next, a detailed example of the association support provided by the attribute association system 120 will be described with reference to FIGS. 4 to 8.

In this example, the core system 110 is set as the target system, and the attributes set by the target system are referred to as the target attributes. Further, the subsystem upstream of the target system in the workflow system is referred to as a source system, and the attributes set by the source system are referred to as source attributes. In the association support, the source attribute having a high similarity to each target attribute is presented to the user as a candidate for the association destination.

FIG. 4 illustrates an example of method of obtaining the score of the source attribute with respect to the target attribute. This score is an evaluation value indicating the similarity of the source attribute to the target attribute, that is, the strength of the association.

The example of FIG. 4 is an example in a case where the core system 110 is set as the target system and the order placement No. is set as the target attribute. In this example, the OCR system 106 and the confirmation correction system 108 are used as source systems. Further, as source attributes, the order number, order date, customer name, and total money set by the OCR system 106, and the matter number, confirmation date and time, and total money set by the confirmation correction system 108 are used.

The attribute association system 120 calculates the score of the source attribute, based on the first score indicating the similarity of the name to the target attribute and the second score indicating the similarity of the data type to the target attribute. That is, the first score is calculated as the similarity between the names of the source attribute and the target attribute, the second score is calculated as the similarity between the data types of both attributes, and the total score of the source attribute is calculated based on those two types of scores.

The name term dictionary 122 is used to calculate the first score. Synonyms and scores are registered in the name term dictionary 122 for each term (for example, a word or compound word) used for the name of the attribute. For example, in the illustrated example, the scores of the synonyms “make order”, “please order”, “order”, and “receive order” for the term “order placement” are 30 points. Although not illustrated, the name term dictionary 122 may include synonyms having scores (for example, 20 points) other than 30 points, for the word “order placement”. In addition, for words and phrases that are not synonyms for terms, for example, the score is set to 0 points.

The calculation of the first score by the attribute association system 120 is performed as follows, for example. That is, in a case where the term included in the name of the source attribute (referred to as the source term) is a synonym of the term included in the name of the target attribute, the score of the synonym in the name term dictionary 122 is used as the score of the source term. The total score of the source term obtained in this way is defined as the first score of the source attribute. This calculation method is only an example. Instead, the similarity between the names of the target attribute and the source attribute, that is, the first score may be calculated by using a method of natural language analysis such as semantic analysis.

The type conversion dictionary 124 is used to calculate the second score. In the type conversion dictionary 124, for each of the data types of the source attributes (referred to as the source types) that is convertible to the data type of the target attribute (referred to as the target type), the score of the similarity of the latter to the former is registered. The same data type is also included in the data type convertible. FIG. 4 illustrates a portion of the type conversion dictionary 124 indicating the score of each data type that can be type-converted to the data type string (=text string type). In this portion, a string type, a date type, an int (=integer) type, and a Boolean type are registered as data types that is convertible to the string type. As the score of each source type, 30 points are registered for the string type, 20 points are registered for the date type and the int type, and 5 points are registered for the Boolean type.

In the calculation of the second score, for example, in a case where the source type is convertible to the target type, the score of the source type in the type conversion dictionary 124 is set as the second score of the source attribute. This calculation method is only an example.

The total score is, for example, the sum of the first score and the second score. In FIG. 4, for example, the source attribute name “order number” set by the OCR system 106 includes the terms “order” and “number” having a score of 30 points respectively for the terms “order placement” and “No.” in the target attribute name “order placement No.”. Therefore, the first score of the source attribute “order number” is 60 points. Further, in the type conversion dictionary 124, since the data type string of the source attribute has a score of 30 points with respect to the data type string of the target attribute, the second score of the source attribute “order number” is 30 points. Therefore, the total score of the source attribute “order number” is 90 points. As another example, since the source attribute “order date” includes the “order” having a score of 30 points with respect to the “order placement”, the first score is 30 points, and the date type which is the data type of the “order date” has a second score of 20 points with respect to the string type. Therefore, the total score of the source attribute “order date” is 50 points.

In addition, setting the sum of the first score and the second score as a total score is only an example. For the calculation of the total score, instead of the sum, various functions using the first score and the second score as input variables can be used. In this function, in a case where the first score is the same, the higher the second score, the higher the total score that is the output, and in a case where the second score is the same, the higher the first score, the higher the total score that is the output. Further, instead of the function, a look-up table that outputs the total score for the combination of the first score and the second score may be used.

Further, in the illustrated example, in the calculation of the total score, in a case where the data length of the source attribute is larger than the data length of the target attribute, the total score is forcibly changed to 0 point, regardless of the total score of the source attribute. This is because in a case where an attempt is made to substitute the value of the source attribute into the value of the target attribute whose data length is shorter than the value of the source attribute, an overflow occurs and an erroneous result is obtained. The total score is a value of 0 or more. The total score of 0 means that the source attribute is not related to the target attribute and the source attribute is not subject to association.

For example, in FIG. 4, the source attribute “customer name” set by the OCR system 106 has a first score of 0 points for the name, but has a second score of 30 points because the data type string is 30 points for the target type string. Therefore, the sum of the first score and the second score is 30 points. However, since the data length of the source attribute “customer name” is 64 bytes, which is longer than the data length of the target attribute “order placement No.” of 12 bytes, the total score of the source attribute “customer name” is forcibly changed to a 0 points. Similarly, the source attribute “total money” set by the OCR system 106 also has a data length longer than the data length of the target attribute, so the total score is 0 points.

However, it is defined that the data type of the source attribute can be type-converted into one or more other data types with similar meanings, and some of one or more other data types may have a data length less than or equal to the data length of the target attribute. In this case, after converting the data type of the source attribute to another data type whose data length is less than or equal to the data length of the target attribute, the total score may remain in the original score, for example, the total score of the first score and the second score.

For example, the data type of the source attribute “confirmation date and time” set by the confirmation correction system 108 is a datetime type in which the data length is 17 bytes and the format is “yyyyMMddHHmmssfff” (fff is a value having three digits after the decimal point of the second). This data length of 17 bytes is longer than the data length of 12 bytes of the target attribute “order placement No.”. Here, it is assumed that it is registered in the attribute association system 120 that the datetime type is convertible to the date type which is the format of “yyyyMMdd” having a data length of 8 bytes. In this case, in a case where the data type of the source attribute “confirmation date and time” is converted from the datetime type to the date type, the data length of the source attribute becomes less than or equal to the data length of the target attribute. Therefore, with respect to the source attribute “confirmation date and time”, the score is evaluated after converting the data type into the date type. In this case, the first score for the name is 0 points, but for the data type, the date type is 20 points for the string type, so the second score is 20 points. Since the date type with an 8-byte length has a data length less than or equal to a 12-byte data length of the target attribute, the date type is not forcibly changed to 0 points. Therefore, the total score of the source attribute “confirmation date and time” after changing to the date type is 20 points.

The data length of the attribute may be regarded as an element of the data format of the attribute together with the data type of the attribute. The data format of an attribute is the format of the value of the attribute. In the above-described example, the type conversion dictionary 124 defines a second score for the source type that is convertible to the target type, but this second score may be regarded as a score indicating the similarity between the target type and the source type. For example, in a case where the target type and the source type are the same, the similarity between the target type and the source type is maximum. In this case, the source type is given the highest score. Therefore, in a case where the data format refers to the data type, the second score can be said to be an evaluation value indicating the similarity between the data formats of the target attribute and the source attribute. Further, in the above-described example, in a case where the data length of the source attribute is larger than the data length of the target attribute, the total score is forcibly set to 0 points. This can be regarded that a two-level similarity is defined in which in a case where the data length of the source attribute is less than or equal to the data length of the target attribute, the former is similar to the latter, and otherwise, the former is not similar to the latter. In this case, the second score, which is the score for the data format, is a negative score (for example, −1 point) in a case where the data lengths are not similar, and the second score is a score specified in the type conversion dictionary 124 in a case where the data lengths are similar. In a case where the second score is negative, the total score is forcibly set to 0 no matter how many points the first score is. The total score of 0 is the lowest point of the total score in the range of 0 or more, and indicates that the source attribute has no relation (or very weakly related) with the target attribute. In one example, a source attribute having a total score of 0 is not included in the options when the user selects a source attribute for the target attribute.

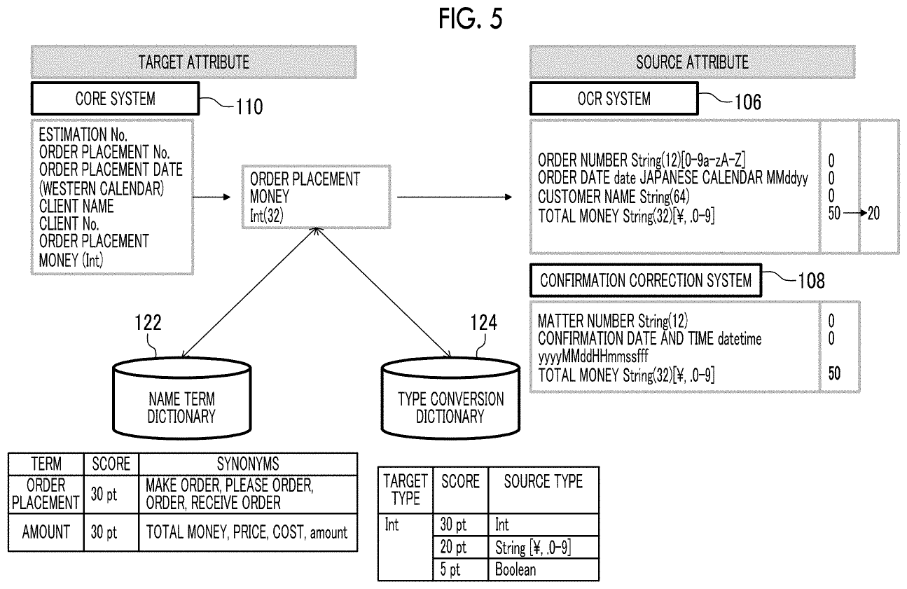

In the example illustrated in FIG. 5, the target attribute is an int-type “order placement money” having a length of 32 bytes. In this example, the source attributes “order number” and “total money” of the OCR system 106 and the source attribute “total money” of the confirmation correction system 108 are all of the string type, but the texts that can be included in the value of the attribute is restricted. For example, the source attribute “order number” of the OCR system 106 is a 12-byte long text string (that is, string), and the texts included in the text string are restricted to half-width alphanumeric texts (that is, numbers from 0 to 9, English lowercase letters, and English capital letters). The data type of “total money” is string [¥, 0.0-9]. That is, the “total money” is a 32-byte text string in which a half-width “Y” mark is followed by a half-width number.

In the type conversion dictionary 124, with respect to the target type int, as the source type, 30 points for the int type, 20 points for the string type in which a half-width “Y” mark is followed by a half-width number, and 5 points for the boolean type are defined. Note that the string type that does not correspond to the format in which a half-width “Y” mark is followed by a half-width number is not registered as a source type corresponding to the target type int of the type conversion dictionary 124. This indicates that such a general string type is not convertible to a target type int. As described above, the source type that is not convertible to the target type is not registered in the type conversion dictionary 124.

In this example, for example, the source attribute of the OCR system 106 will be described. First, the “order number” includes the term “order” of 30 points with respect to the term “order placement” included in the name of the target attribute, so that the first score is 30 points. However, the source type is a string type that can include lowercase and uppercase alphabets, which is not convertible to a target type int. In this example, in a case where the source type is not convertible to the target type, the second score is, for example, a value indicating that the total score is forcibly set to 0 points. Therefore, in the example of FIG. 5, the total score of the source attribute “order number” with respect to the target attribute “order placement money” is 0 points. Similarly, the total score of the “order date” is 0 because the data type date is not convertible to the target type. With respect to the “customer name”, the source type is not convertible to the target type because the first score for the name is 0 and the data length is larger than the data length of the source. From these facts, the total score of the “order date” is 0 points. Further, since the source attribute “total money” includes the term “total money” of 30 points with respect to the term “amount” of the name of the target attribute in the name term dictionary 122, the first score is 30 points. Further, since the data type string [¥,0.0-9] is 20 points for the target type int, the second score is 20 points. From these, the total score of the source attribute “total money” of the OCR system 106 is 50 points.

However, in a case where it is found that the source attribute “total money” of the OCR system 106 is the same as the source attribute “total money” of the confirmation correction system 108, the total score of the source attribute “total money” of the OCR system 106 with relatively earlier workflow order is deducted by a predetermined score (30 points in the illustrated example).

In a case where the same attribute is set in different subsystems in the workflow, it means that the value of that attribute set by one subsystem is modified or overwritten by another subsystem that is later in the workflow. Therefore, for the same attribute, the value set by the later subsystem is more likely to be more appropriate for the value of the target attribute than the value set by the earlier subsystem. Therefore, the total score 50 points of the source attribute “total money” of the confirmation correction system 108 which is later in the order is maintained, and the total score of the source attribute “total money” of the OCR system 106 which is earlier in the order is deducted. In a case where the total score becomes less than or equal to 0 points due to this deduction, the total score is changed to the lowest point (for example, 5 points) higher than 0 points. The total score is a value of 0 points or more, and 0 points is a value indicating that the source attribute is not related to the target attribute at all. On the other hand, the source attribute whose total score is deducted by a predetermined value receives deduction, but it cannot be said that the source attribute is completely unrelated to the target attribute in terms of the attribute name and data format. Therefore, the deducted source attribute keeps the lower limit of the score after the deduction higher than zero points such that the deducted source attribute is not excluded from the options presented to the user who finally determines the association between the attributes. The fact that the total score is higher than 0 points corresponds to the threshold value for selecting the source attribute as a candidate to be displayed on the GUI screen 800.

As described above, in the example illustrated in FIG. 5, among the source attribute “total money” of the OCR system 106 and the source attribute “total money” of the confirmation correction system 108, which are related to each other, the total score of the former which is upstream is deducted. Due to such deductions, the attributes of the downstream subsystem are treated as having a stronger relationship with the target attributes.

In a case where the total score of each source attribute with respect to the target attribute is obtained by the process described above, the attribute association system 120 then generates a user interface (UI) screen for determining the source attribute to be associated with the target attribute, and presents the UI screen to the user. This UI screen is, for example, in the form of a graphical UI (GUI) (hereinafter referred to as a GUI screen).

In the present exemplary embodiment, the source attributes are classified into four types: (a) automatic mapping candidate, (b) recommendation candidate, (c) general candidate, and (d) non-candidate, based on the total score.

The source attribute belonging to the classification (a), that is, the automatic mapping candidate is a source attribute that is automatically mapped, that is, automatically associated with the target attribute. The automatic mapping candidate is displayed as an automatic mapping result for the target attribute, on the GUI screen. This automatic mapping result can be changed to another candidate by the user, but in a case where the user does not make such a change, the automatic mapping result is registered in the target system as the final mapping result for the target attribute. That is, it can be said that the automatic mapping candidate is a source attribute tentatively selected as a source attribute associated with the target attribute. The automatic mapping candidates are displayed on the GUI screen in a more emphasized display form than the recommendation candidates belonging to the classification (b) and the general candidates belonging to the classification (c). In a normal usage scene, there is at most one mapping candidate for one target attribute.

The recommendation candidate belonging to the classification (b) is a source attribute recommended to the user for mapping. Since the recommendation candidate has a lower degree of association (that is, the total score) with the target attribute than the automatic mapping candidate, the automatic mapping is not performed and only the recommendation is made to the user. The recommendation candidate is displayed on the GUI in a more emphasized display form than the general candidate belonging to the classification (c). The recommendation candidate is qualified to be associated with the target attribute only after being selected for mapping by the user on the GUI screen. Conversely, source attributes that are simply recommended and not selected as a mapping target by the user are not associated with the target attribute. The number of recommendation candidates is limited to at most one or a relatively small number.

The general candidate belonging to the classification (c) is a source attribute presented to the user as an option for mapping. The total score of the general candidate is lower than the score of the recommendation candidate, but higher than 0.

The non-candidate belonging to the classification (d) is an option for mapping, that is, a source attribute that is not a candidate. The total score of the source attribute corresponding to the non-candidate is 0 points. 0 points is the lowest point in the range of values that the total score can take. It can be said that the source attribute with a total score of 0 is not related to the target attribute in terms of both the name and the data format.

The automatic mapping candidate is a source attribute that is extremely likely to have the same attribute as the target attribute, and conversely, it is extremely unlikely that an error occurs even in a case where the automatic mapping candidate is associated with the target attribute. On the other hand, the recommendation candidate is likely to have the same attribute as the target attribute, but may not have the same attribute to some extent, so that it is not automatically associated and only recommended to the user. The general candidate may or may not have the same attributes as the target attribute, so that the general candidate is not recommended and is simply presented to the user as a general candidate. A non-candidate is a source attribute that cannot be the same attribute as the target attribute, and is not even selected as a candidate.

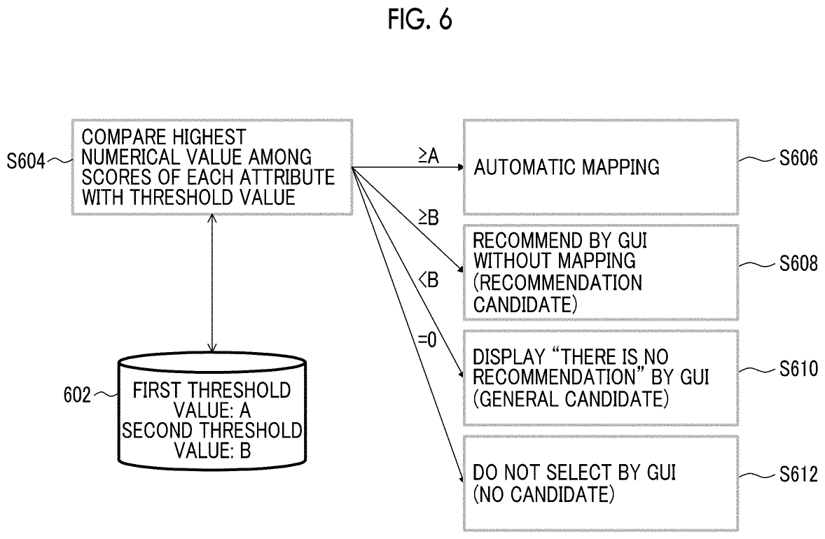

With reference to FIG. 6, the classification process of the source attribute by the attribute association system 120 will be illustrated. In this process, two threshold values stored in the threshold value storage unit 602 in the attribute association system 120, that is, a first threshold value A and a second threshold value B (where A>B) are used.

With respect to each target attribute, the attribute association system 120 calculates the total score of each source attribute for the target attribute. Then, the source attribute having the highest total score is searched for, and the highest point is compared with the first threshold value A and the second threshold value B (S604). Then, in a case where the highest point is equal to or higher than the first threshold value A, the source attribute having the highest point is selected as the classification (a), that is, the automatic mapping candidate (S606). In a case where the highest point is equal to or higher than the second threshold value Band is less than the first threshold value A, the source attribute having the highest point is selected as a recommendation candidate (S608). In a case where the highest point is less than the second threshold value B but is higher than 0, the source attribute having the highest point is set as a general candidate (S610). Then, in a case where the highest point is 0, the source attribute having the highest point is set as a non-candidate (S612).

The process illustrated in FIG. 6 is a classification process for a source attribute having the highest total score for a certain target attribute. With respect to source attributes whose total score is lower than the highest point, in one example, the source attributes with a total score higher than 0 are uniformly considered as general candidates, and the source attributes with a total score of 0 are considered as non-candidates. In this example, only the single source attribute having the highest point can be an automatic mapping candidate or a recommendation candidate.

Further, as another example, source attributes other than the source attribute having the highest point may be classified in the same manner as illustrated in FIG. 6 except for automatic mapping (S606). Since the number of automatic mapping candidates is limited to one at most, source attributes other than the source attribute having the highest point are not automatic mapping candidates. Among source attributes other than the source attribute having the highest point, source attributes having total score equal to or higher than the first threshold value A are not automatic mapping candidates but recommendation candidates. In addition, in a case where the upper limit is set for the number of recommendation candidates, among source attributes whose total score is equal to or higher than the second threshold value B, the source attributes with higher total scores up to the number of upper limit from descending order except for the automatic mapping candidates are considered recommendation candidates, and the source attributes exceeding that number are considered general candidates.

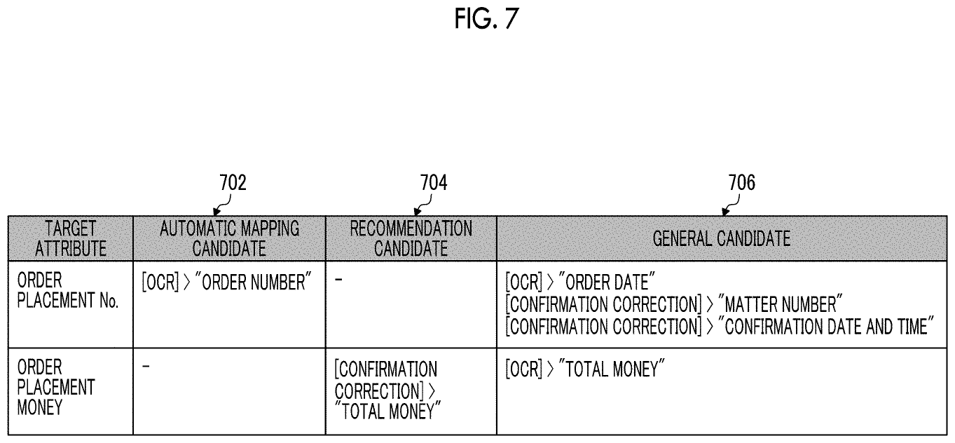

FIG. 7 illustrates the data on the classification result of the source attribute by the attribute association system 120 with respect to the order placement No. and the order placement money which are two target attributes of the core system 110 as the target system.

In this example, with respect to the order placement No., the source attribute expressed as “[OCR]>“order number”” is selected as the automatic mapping candidate 702. The expression “[OCR]>“order number”” refers to an attribute named “order number” among the attributes set by the OCR system 106. That is, in this expression, the left side of “>” is the identification name of the source system, and the right side is the name of the attribute set by the source system. In addition, with respect to the order placement No., three attributes such as “[OCR]>“order date””, “[confirmation correction]>“matter number””, and “[confirmation correction]>“confirmation date and time”” are selected as general candidates 706. Of these, for example, “[confirmation correction]>“matter number”” indicates an attribute whose name is “matter number” among the attributes set by the confirmation correction system 108.

Further, in the example of FIG. 7, for the target attribute “order placement money”, the attribute “total money” set by the confirmation correction system 108 is selected as the recommendation candidate 704, and the attribute “total money” set by the OCR system 106 is selected as the general candidate 706.

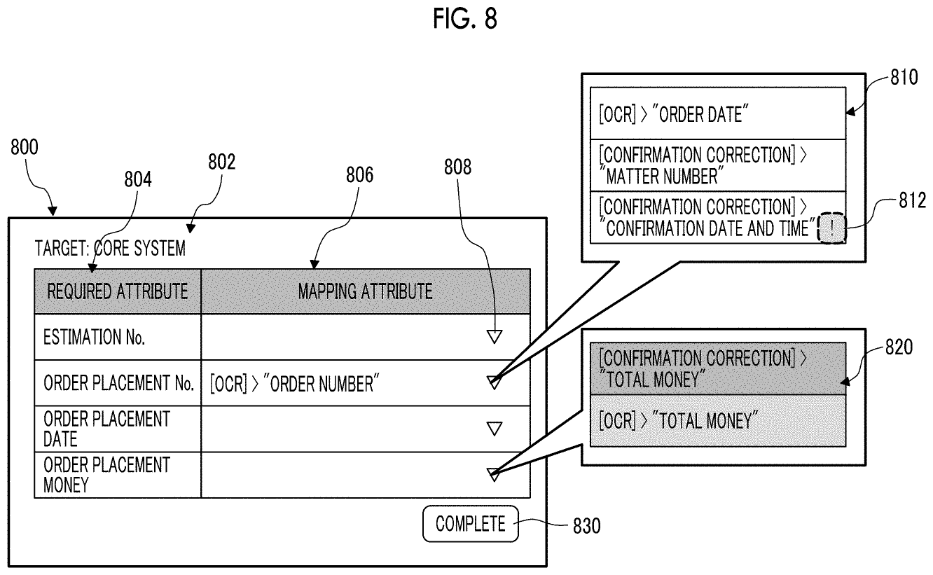

FIG. 8 illustrates an example of the GUI screen 800 presented to the user by the attribute association system 120.

This GUI screen 800 is for the case where the core system 110 is used as the target system, and the name 802 of the target system is displayed within the same screen. Further, on the GUI screen 800, pairs of the required attribute 804 and the mapping attribute 806 are listed and displayed. The required attribute 804 is a target attribute set by the target system, and the mapping attribute 806 is a source attribute associated with the target attribute.

In a case where the attribute association system 120 has found the automatic mapping candidates for the target attribute by the method described above, at a time when the GUI screen 800 is first presented to the user, the automatic mapping candidates are displayed in the field of the mapping attribute 806 for the target attribute. In a case where the GUI screen 800 illustrated in FIG. 8 is such a “presented first” screen, the source attribute “order number” of the OCR system 106, which is the mapping attribute 806 for the “order placement No.” of the required attribute 804, is automatically mapped. On the other hand, no automatic mapping candidates have been found with respect to “estimation No.”, “order placement date”, and “order placement money”.

The mapping attribute displayed in the field of mapping attribute 806 is expressed by a set of information specifying the source system for setting the source attribute and the name of the source attribute. Among the mapping attributes “[OCR]>“order number”” for “order placement No.” in the illustrated example, [OCR] indicates the OCR system 106 which is the source system for setting the mapping attributes. The “order number” is the attribute name of the mapping attribute.

A button 808 for calling the candidate list 810 of the mapping attribute 806 is displayed on the right side of the field of the mapping attribute 806. The candidate list 810 or 820 is displayed, for example, in the form of a pull-down menu.

In the illustrated example, for example, in a case where the button 808 corresponding to the required attribute “order placement No.” is pressed by the user, the candidate list 810 is displayed. In the candidate list 810, three source attributes that are general candidates are listed.

The source attribute of the candidate illustrated in the candidate list 810 is also expressed by a set of information specifying the source system for setting the source attribute and the name of the source attribute. This expression makes it easy for the user to understand which attribute of which subsystem each displayed candidate is.

A warning mark 812 is displayed in the bottom candidate “[confirmation correction]>“confirmation date and time”” illustrated in the candidate list 810. The warning mark 812 indicates that type-conversion is required to map the candidate to the required attribute “order placement No.”. In response to an operation such as clicking the warning mark 812, a message explaining the required type-conversion, such as “type-conversion from datetime type to date type is required for mapping” may be displayed.

Further, for example, in a case where the button 808 corresponding to the required attribute “order placement money” is pressed by the user, the candidate list 820 is displayed. The candidate list 820 includes two candidates. The first candidate “[confirmation correction]>“total money”” among the candidates is a recommendation candidate, and the display is emphasized more than the general candidate “[OCR]>“total money”” below. The method of emphasizing the display of recommendation candidates for general candidates is not particularly limited. For example, the emphasis may be made by making the color of the texts or the background more prominent.

The example of the required attributes “order placement No.” and “order placement money” illustrated in FIG. 8 is the example of the case where the first threshold value A is 80 points and the second threshold value B is 50 points in the example of the total score illustrated in FIGS. 4 and 5.

The user determines the mapping attribute 806 for each required attribute 804, on the displayed GUI screen 800. For example, a user who recognizes that the mapping attribute 806 is not displayed in the required attribute “order placement money” calls the candidate list 820, and selects the candidate to be the mapping attribute from among the candidates listed in the candidate list 820. In a case where the user selects, for example, “[confirmation correction]>“total money”” from the candidate list 820, the attribute association system 120 displays “[confirmation correction]>“total money”” in the field of the mapping attribute 806 for the “order placement money”. Further, the user may call the candidate list 810 and confirm another candidate to confirm whether the “[OCR]>“order number”” displayed in the mapping attribute 806 field of the required attribute “order placement money” is correct. In a case where the candidate list 810 has a source attribute to be mapped that is more appropriate than “[OCR]>“order number””, the user selects the source attribute on the candidate list 810. In response to the selection, the attribute association system 120 displays the selected source attribute in the mapping attribute 806 field. Further, in a case where it is confirmed that “[OCR]>“order number”” in the mapping attribute 806 field is correct, the candidate list 810 may be simply closed.

It should be noted that some of the required attributes 804 do not need to be associated with the source attribute. For example, a target attribute for which a user inputs a value on the target system does not need to be associated with the source attribute. The mapping attribute 806 is left blank for the required attribute that does not need to be associated with the source attribute.

In a case where the user ends designating the mapping attribute 806 to the required attribute in the target system, the user presses the complete button 830. In response to this pressing, the attribute association system 120 registers, in the target system, the information on the mapping attribute 806 for each required attribute 804 displayed on the GUI screen 800.

The target system acquires the value of the mapping attribute registered in association with the required attribute from the source system, and executes the process by setting the acquired value of the mapping attribute to the value of the required attribute.

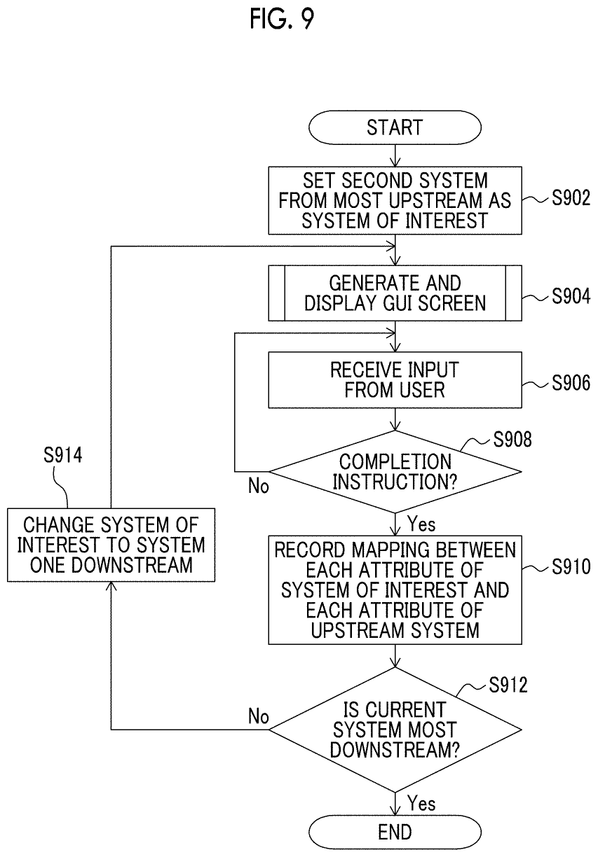

Next, an example of the processing procedure of the attribute association system 120 will be described with reference to FIGS. 9 to 11.

FIG. 9 illustrates an example of the overall processing procedure.

For this process, the attribute association system 120 receives an input of information specifying the configuration of the workflow system. This information includes information specifying each subsystem that constitutes the workflow, information specifying the order relationship of those subsystems in the workflow, and information specifying the name and data format of the attributes set by each subsystem.

The attribute association system 120 associates attributes between subsystems in order from the upstream side of the workflow. In the procedure illustrated in FIG. 9, the attribute association system 120 sets a second subsystem from the most upstream in the workflow as the system of interest (S902), and executes a process for determining the association of the attribute set by the upstream subsystem with respect to each attribute set by the system of interest.

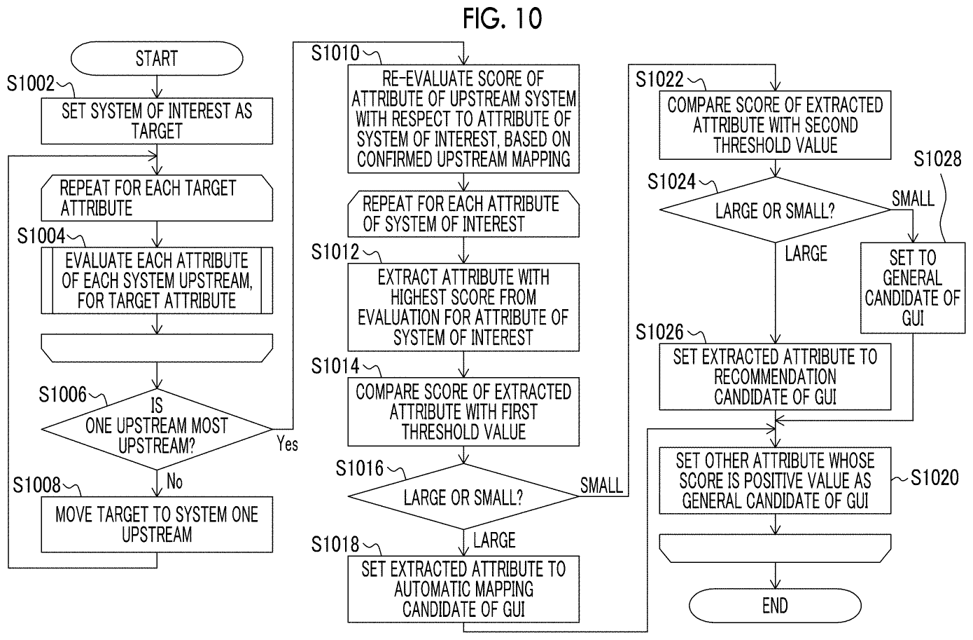

In this process, the attribute association system 120 generates and displays the GUI screen 800 for association with the system of interest as the target system (S904). A detailed example of the process of step S904 will be described later with reference to FIG. 10.

Next, the attribute association system 120 receives an input from the user to the GUI screen 800 (S906). Examples of the input from the user include calling the candidate list 810 or 820, selecting a mapping attribute from the candidate list 810 or 820, pressing the complete button 830, and the like. Next, the attribute association system 120 determines whether or not the user's input is the press of the complete button 830 (S908), and in a case where the result of this determination is No (negative), returns to step S906 to receive the next input from the user. In a case where the determination result in step S908 is Yes, the attribute association system 120 registers the association between the required attribute (=target attribute) 804 displayed on the GUI screen 800 and the mapping attribute (=source attribute) with the target system (S910).

Then, the attribute association system 120 determines whether or not the current system of interest is the most downstream subsystem in the workflow (S912). In a case where the result of this determination is No, the subsystem which is one downstream from the current system of interest in the workflow is set as a new system of interest (S914), and the processes from steps S904 to S912 are repeated. Ina case where the determination result in step S912 is Yes, the attribute association system 120 ends the overall processing procedure illustrated in FIG. 9.

As described above, in the procedure of FIG. 9, the association between the attributes between the subsystems is determined in order from the upstream in the workflow.

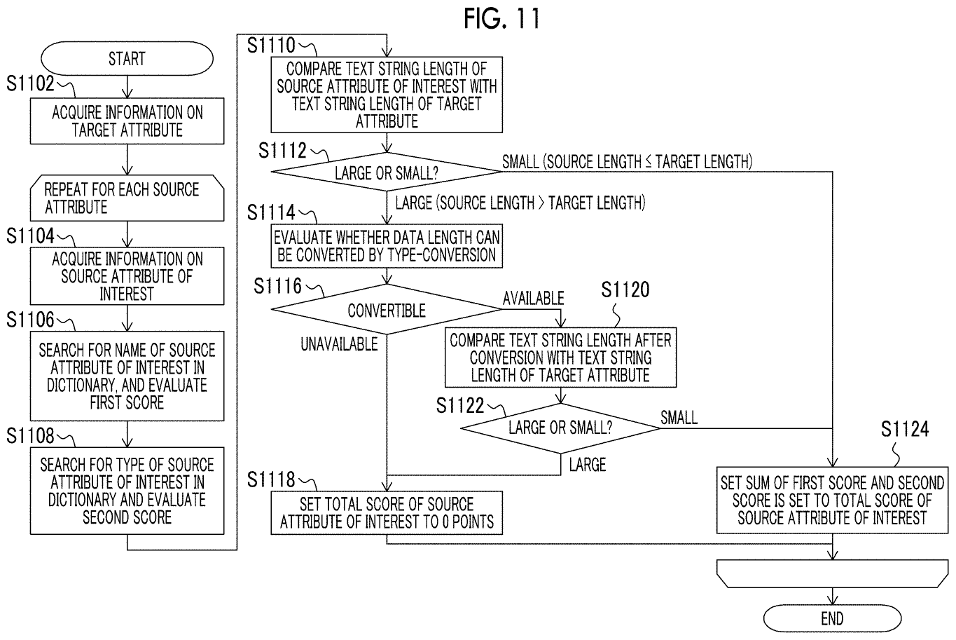

Next, a detailed example of the process of step S904 described above will be described with reference to FIG. 10. In this procedure, the attribute association system 120 first sets the system of interest determined in step S902 or S914 as the target system (S1002), and repeats the process of step S1004 for each attribute of the target system, that is, the target attribute. In step S1004, for each target attribute, the degree of association of each attribute, that is, the source attribute, of each upstream subsystem is evaluated. An example of the detailed process of step S1004 will be described later with reference to FIG. 11.

After step S1004, the attribute association system 120 determines whether or not a subsystem, that is one upstream of the target system in the workflow, is the most upstream in the workflow (S1006). In a case where the result of this determination is No, the attribute association system. 120 sets a subsystem one step upstream of the current target system in the workflow as a new target system (S1008), and repeats the processes of steps S1004 to S1006.

In a case where the determination result in step S1006 becomes Yes due to this repetition, the attribute association system. 120 re-evaluates the score of the degree of association of the attributes of each upstream subsystem with respect to each attribute of the system of interest (S1010). This re-evaluation is performed based on the association of attributes between decided upstream subsystems. That is, by executing steps S904 to S914 of the procedure of FIG. 9 from the upstream side of the workflow, in order from the upstream side, the attributes of the subsystem which is further upstream, related to the attributes of the subsystem, are decided by the user's operation on the GUI screen 800. In the re-evaluation, among the attributes whose associations are decided in this way, for example, the total score of the attribute most downstream is maintained, and the total score of the attributes other than the most downstream is deducted. The deduction width may be a fixed value, or the deduction width may be relatively large toward the upstream. In this example, among the source attributes decided to be related to each other, the total scores of the source attributes other than the most downstream source attribute are deducted, but this is only an example. Instead of deducting points, for example, the total score of the most downstream source attribute may be added.

For example, in the examples illustrated in FIGS. 1 and 5, in the processes of steps S904 to S914 when the confirmation correction system 108 is the system of interest, the attribute “total money” of the OCR system 106 is associated with the attribute “total money” of the confirmation correction system 108. Therefore, in the evaluation of the degree of association with the attribute “order placement money” of the core system 110, when re-evaluating the total score calculated according to the name and data format, the total score of the attribute “total money” of the confirmation correction system 108 on the downstream side is maintained, and the total score of the attribute “total money” of the OCR system 106 on the upstream side is deducted by a predetermined value.

The deducted source attribute has a lower level of recommendation to the user on the GUI screen 800 than before the deduction. That is, in a case where the total score, which has been equal to or higher than the first threshold value A before being deducted, falls below the first threshold value A due to the deduction, the source attribute is no longer displayed as an automatic mapping candidate on the GUI screen 800, and is displayed as a recommendation candidate or a general candidate. In this way, the deducted source attribute is less likely to be displayed as a strongly related candidate for the target attribute.

Next, the attribute association system 120 executes the processes of steps S1012 to S1020 for each attribute of the system of interest.

That is, the attribute association system 120 extracts a source attribute with the highest total score obtained in step S1004 from among source attributes (S1012), and compares the total score of the extracted source attribute with the first threshold value A (S1014). As a result of the comparison, it is determined whether or not the total score is equal to or higher than the first threshold value A (S1016), and in a case where the total score is equal to or higher than the first threshold value A, the extracted source attribute is set as an automatic mapping candidate on the GUI screen 800 (S1018).

After that, the attribute association system sets each source attribute whose total score calculated in step S1004 is larger than 0 as a general candidate of the GUI screen 800 (S1020), and ends the process for the attribute of the system of interest.

In a case where the total score is less than the first threshold value A in the determination of step S1016, the attribute association system 120 compares the total score of the extracted attributes with the second threshold value B (S1022), and as a result of the comparison, determines whether or not the total score is equal to or higher than the second threshold value B (S1024). In a case where the total score is equal to or higher than the second threshold value B in this determination, the extracted source attribute is set as a recommendation candidate on the GUI screen 800 (S1026). In a case where the total score is less than the second threshold value B in the determination of step S1024, the extracted source attribute is set as a general candidate of the GUI screen 800 (S1028). After step S1026 or S1028, each source attribute whose total score calculated in step S1004 is larger than 0 is set as a general candidate of the GUI screen 800 (S1020), and the process for the attribute of the system of interest is ended.

In this way, according to the procedure of FIG. 10, automatic mapping candidates, recommendation candidates, and general candidates are set for each attribute of the system of interest, and the GUI screen 800 can be displayed.

Next, with reference to FIG. 11, a detailed procedure of the process of step S1004 described above will be illustrated.

In this procedure, the attribute association system 120 first acquires information on the target attribute of interest in step S1004, for example, name, data type, and data length (S1102).

Next, the attribute association system 120 pays attention to each source attribute, and executes the processes of steps S1104 to S1124 for each source attribute of interest. In this process, first, information such as the name, data type, and data length of the source attribute of interest is acquired (S1104). Then, from the name of the target attribute and the name of the source attribute of interest, the first score indicating the similarity between the names is calculated with reference to the name term dictionary 122 (S1106). Further, from the data type of the target attribute and the data type of the source attribute of interest, the second score indicating the similarity between the data types is calculated with reference to the type conversion dictionary 124 (S1108). Next, the data length of the target attribute is compared with the data length of the source attribute of interest (S1110), and it is determined whether the latter is less than or equal to the former (S1112). In this determination, in a case where the data length of the source attribute of interest is less than or equal to the data length of the target attribute (the determination result in step S1112 is “small”), the sum of the first score and the second score is set to the total score of the source attribute of interest (S1124), and the process for the source attribute is completed.

In the determination of step S1112, in a case where the data length of the source attribute of interest is greater than the data length of the target attribute, the attribute association system 120 evaluates whether the source attribute is convertible to another data type with a different data length (S1114). For example, in the above example, an 8-byte date type is registered as a conversion destination for a 17-byte datetime type, in the attribute association system 120. In this way, it is checked in step S1114 whether another data type having a different data length is registered for the data type of the source attribute. As a result of this evaluation, it is determined whether or not it is convertible (S1116), and in a case where the result of the determination is “not convertible”, the total score of the source attribute of interest is set to 0 point (S1118), and the process for the source attribute is ended. In a case where the result of the determination in step S1116 indicates that the conversion is possible, the data length of the converted data type is compared with the data length of the target attribute (S1120), and it is determined whether the former is less than or equal to the latter (S1122). In a case where the data length of the converted data type is less than or equal to the data length of the target attribute, the sum of the first score and the second score is set to the total score of the source attribute of interest (S1124), and the process for the source attribute is completed. In a case where the data length of the converted data type is longer than the data length of the target attribute in the determination of step S1122, the total score of the source attribute of interest is set to 0 point (S1118), and the process for the source attribute is ended.

According to the processing procedure of FIG. 11 described above, the total score of each source attribute for the target attribute is calculated.

In the processing procedure of FIGS. 9 to 11 described above, the attributes of the subsystems are associated with the source attributes in order from the subsystem upstream in the workflow. By doing so, redoing the work of associating the attributes of the subsystem is suppressed or reduced.

That is, in a case where the association of the attributes set by the downstream apparatuses is completed first and then the attributes set by the upstream apparatuses are associated with each other, the deduction for the total score of those attributes changes according to the result of the association between the upstream attributes. Therefore, the total score of each source attribute changes, and as a result, the automatic mapping candidates and recommendation candidates presented on the GUI screen 800 by the attribute association system 120 change, the determination of the user who sees these candidates changes, and the association may be redone. On the other hand, in a case where the association is decided from the upstream side as in the present exemplary embodiment, such redoing is unlikely to occur.

The process of the present exemplary embodiment has been described above.

In the procedure illustrated in FIG. 9, all the subsystems are set as the system of interest in order from the upstream side in the workflow, and the GUI screen 800 for the system of interest is provided. As another example, the attribute association system 120 may not provide the GUI screen 800 for the system of interest for which the automatic mapping candidates could be obtained for all the attributes, and register the automatic mapping candidates in the system of interest in association with each of these attributes.

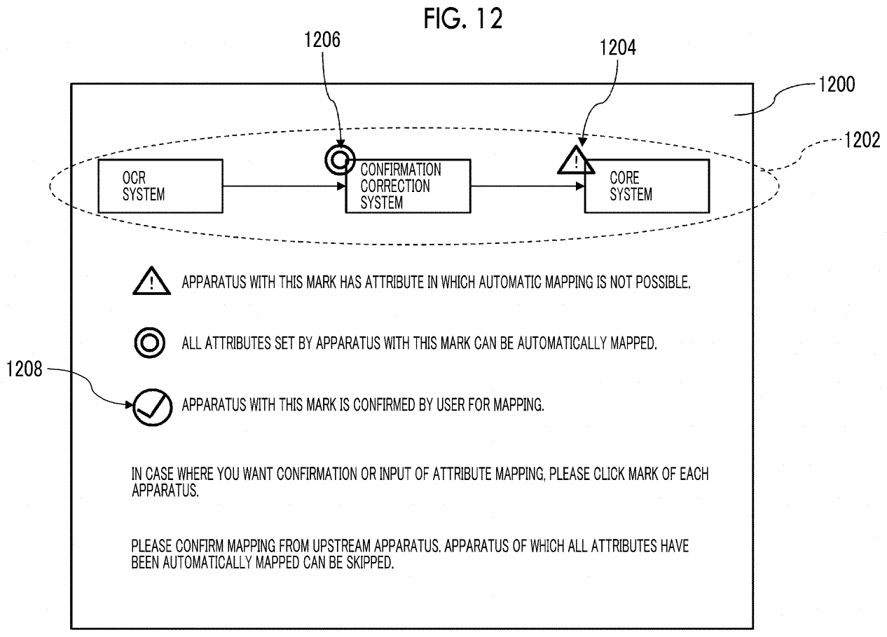

Further, the attribute association system 120 may display a progress screen 1200 as illustrated in FIG. 12 on the screen, and prompt the user to confirm the attribute mapping in order from the subsystem upstream in the workflow. The workflow diagram 1202 is illustrated on the progress screen 1200. The workflow diagram 1202 is composed of blocks respectively indicating subsystems constituting the workflow and arrows indicating the flow of process between the blocks. In addition, in the vicinity of the block of each subsystem in the workflow diagram, a mark 1204, 1206, or 1208 indicating the progress status of attribute mapping in the subsystem is displayed. The mark 1204 indicates that some of the attributes set by the subsystem cannot be automatically mapped to the source attribute by the procedure of FIGS. 10 and 11. The mark 1206 indicates that all the attributes set by the subsystem can be automatically mapped to the source attributes (however, the mapping deciding operation by the user has not been received). Further, the mark 1208 indicates that the user has completed the deciding operation for the mapping of the attributes set by the subsystem.

On the progress screen 1200, an explanation of each mark and a message prompting the user to confirm or input the mapping from the upstream are displayed. The GUI screen 800 may be opened by selecting the mark 1204 or 1206 attached to a subsystem only in a case where all subsystems upstream of the subsystem have been automatically mapped or the deciding by the user has been completed. That is, in a case where at least one of the upstream subsystems has the mark 1204 attached, the mark 1204 or 1206 attached to a certain subsystem becomes unselectable, and otherwise becomes selectable.

The attribute association system 120 displays a progress screen 1200 in which the mark 1204 or 1206 is displayed for each subsystem when the processes illustrated in FIGS. 10 and 11 are completed. In a case where the marks 1204 to 1208 of a certain subsystem are selected by a click operation or the like, the attribute association system 120 presents the GUI screen 800 (see FIG. 8) to the user, and receives confirmation or input of the association. In a case where the user presses the complete button 830 on the GUI screen 800, the attribute mapping of the subsystem is decided by the user, and the mark 1208 is displayed for the block of the subsystem on the progress screen 1200.

The attribute association system 120 may further have a function of learning the selection result of the mapping attribute by the user on the GUI screen 800 and reflecting the selection result in the subsequent calculation of the score. In a case where the user selects a candidate in the candidate list 810 or 820 (see FIG. 8) of the GUI screen 800 as the mapping attribute 806, this function performs learning such that the candidate's score for the required attribute 804 (=target attribute) becomes high in subsequent attribute mappings. This learning is performed, for example, by increasing the score of the term included in the name of the candidate selected by the user for the corresponding term in the name of the required attribute.

For example, a case is considered where the user selects “[confirmation correction]”>“matter number” from the candidate list 810 as the mapping attribute 806, with respect to the required attribute “estimation No.”.

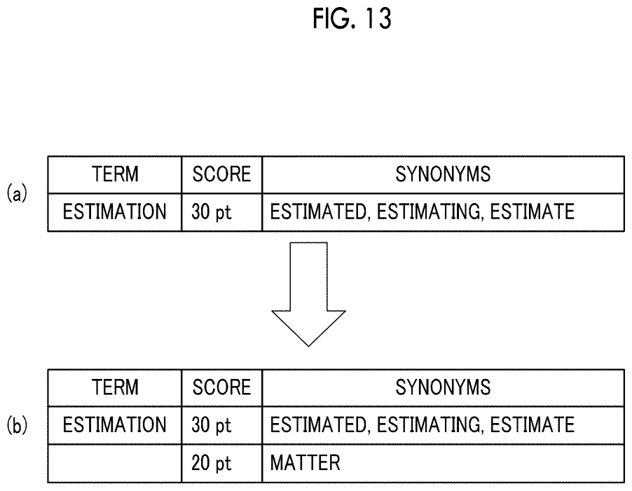

In the name term dictionary 122 before this selection is performed, as the entries for the term “estimate”, it is assumed that only synonyms “estimated”, “estimating”, and “estimate” with a score of 30 points as illustrated in state (a) of FIG. 13 are registered. At this point, the term “matter” is not a synonym for the term “estimate.”. Therefore, the first score indicating the similarity of the attribute name to the required attribute “estimation No.” in the source attribute “[confirmation correction]>“matter number”” is only the score of the synonym “number” for the term “No.”. As a result, even with the total score obtained by adding the second score indicating the similarity of the data types, the source attribute does not become an automatic mapping candidate but remains as a general candidate.

After that, it is assumed that the user selects the source attribute “[confirmation correction]”>“matter number” from the candidate list as the mapping attribute 806 of the required attribute “estimation No.”, in the candidate list of the GUI screen 800. In this case, the attribute association system 120 recognizes that the “matter number” has the same meaning as the “estimation No.”, and registers the term “matter” as a synonym for the term “estimate” in the name term dictionary 122. In this case, the score of the “matter” in the name term dictionary 122 may be a predetermined value. In addition, as another example, the score that the total score of the source attribute “[confirmation correction]”>“matter number” is missing to be equal to or higher than the reference point for selecting the automatic mapping candidate, that is, the first threshold value A may be used as the score of the term “matter”. For example, in a case where the total score of the source attribute “[confirmation correction]”>“matter number” is 60 points and the first threshold value A is 80 points, the score that the source attribute is missing to be an automatic mapping candidate is 20 points. Therefore, the score in a case where the term “matter” is registered in the name term dictionary 122 as a synonym for the term “estimate” may be 20 points. The state in which the synonym “matter” is added to the entry related to the term “estimate” in the name term dictionary 122 is illustrated in the state (b) of FIG. 13. In the state (b) of FIG. 13, the score for the synonym “matter” is 20 points.

The example of FIG. 13 is an example in which the term “matter” is not registered as a synonym in the name term dictionary 122, before the user selects the mapping attribute. On the other hand, before the selection, the term “matter” may have been registered in the name term dictionary 122 as a synonym for the term “estimate”. In this case, the attribute association system 120 increases the score of the synonym “matter” for the term “estimate” in the name term dictionary 122 according to the selection of the source attribute “[confirmation correction]>“matter number””. The amount of increase may be a predetermined value, or may be a score that the source attribute “[confirmation correction]>“matter number”” is missing to be an automatic mapping candidate. Further, not only the score of the synonym “matter” for the term “estimate” in the name term dictionary 122 but also the score of the synonym “number” for the term “No.” may be increased at the same time. In this case, the increase may be, for example, a value obtained by dividing equally the above-described missing scores by “matter” and “number”.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
select candidates for second data to be associated with first data, the first data being data which is set by a first apparatus among a plurality of apparatuses constituting a workflow, the second data being data pieces which are set by apparatuses other than the first apparatus among the plurality of apparatuses, based on a first similarity which is a similarity between names of the first data and the second data, and a second similarity which is a similarity between data formats of the first data and the second data; and
generate a first screen in which, for each of the selected candidates, a name of the first data, a name of the candidate, and a name of the apparatus that sets the candidate are displayed in association with each other, the first screen being used for receiving selection of the second data to be associated with the first data, from among the candidates.

2. The information processing apparatus according to claim 1,
wherein the second data is data pieces which are set by apparatuses upstream of the first apparatus in the workflow, and
the processor is configured to, in order from the apparatus upstream in the workflow, use the apparatus as the first apparatus to generate the first screen, and use the generated first screen to receive selection of the second data to be associated with the first data from among one or more candidates.

3. The information processing apparatus according to claim 2,
wherein among the second data pieces associated with each other as a result of the selection performed in order from the apparatus upstream in the workflow, as the apparatus that sets the second data is more upstream in the workflow, the second data is less likely to be displayed on the first screen as a candidate having a stronger relationship with the first data.

4. The information processing apparatus according to claim 1,
wherein among the second data pieces associated with each other, as the apparatus that sets the second data is more upstream in the workflow, the second data is less likely to be displayed on the first screen as a candidate having a stronger relationship with the first data.

5. The information processing apparatus according to claim 1,
wherein the data format includes at least a data type, and
among the second data pieces, second data pieces having the same data type as the first data are determined to have the second similarity higher than second data pieces that do not have the same data type.

6. The information processing apparatus according to claim 5,
wherein among the second data pieces that do not have the same data type as the first data, second data pieces that are convertible to have the same data type as the first data by type-conversion are determined to have the second similarity higher than second data pieces that are not convertible to have the same data type as the first data.

7. The information processing apparatus according to claim 1,
wherein on the first screen, among the selected candidates, the candidates that require type-conversion to have the same data type as the first data are displayed in a display mode distinguishable from the candidates that do not require type-conversion to have the same data type as the first data.

8. The information processing apparatus according to claim 1,
wherein the data format includes a data length, and among the second data pieces, second data having a data length longer than a data length of the first data is not selected as the candidate.

9. The information processing apparatus according to claim 1, wherein the processor is configured to:
in a case where a user selects the candidate to be associated with the first data from among the candidates displayed on the first screen, perform learning such that with respect to the second data which is the candidate selected from the user, a high degree of the first similarity between the names of the first data and the second data is calculated.

10. The information processing apparatus according to claim 1,
wherein in selection of the candidate, the second data whose score calculated based on the first similarity and the second similarity is higher than a predetermined first threshold value is selected as the candidate, and
on the first screen, in a case where there is the candidate whose score is equal to or higher than a second threshold value higher than the first threshold value, the candidate is displayed in a tentatively selected state to be associated with the first data, and in a case where the user does not perform an operation to select the candidate to be associated with the first data on the first screen, the candidate in the tentatively selected state is considered to have been selected as the candidate to be associated with the first data.

11. A non-transitory computer readable medium storing a program causing a computer to execute a process comprising:
selecting candidates for second data to be associated with first data, the first data being data which is set by a first apparatus among a plurality of apparatuses constituting a workflow, the second data being data pieces which are set by apparatuses other than the first apparatus among the plurality of apparatuses, based on a first similarity which is a similarity between names of the first data and the second data, and a second similarity which is a similarity between data formats of the first data and the second data; and
generating a first screen in which, for each of the selected candidates, a name of the first data, a name of the candidate, and a name of the apparatus that sets the candidate are displayed in association with each other, the first screen being used for receiving selection of the second data to be associated with the first data, from among the candidates.

12. An information processing apparatus comprising:
means for selecting candidates for second data to be associated with first data, the first data being data which is set by a first apparatus among a plurality of apparatuses constituting a workflow, the second data being data pieces which are set by apparatuses other than the first apparatus among the plurality of apparatuses, based on a first similarity which is a similarity between names of the first data and the second data, and a second similarity which is a similarity between data formats of the first data and the second data; and
means for generating a first screen in which, for each of the selected candidates, a name of the first data, a name of the candidate, and a name of the apparatus that sets the candidate are displayed in association with each other, the first screen being used for receiving selection of the second data to be associated with the first data, from among the candidates.
